(19) United States
(12) Patent Application Publication
(10) Pub. No.: US 2018/0243601 A1
(43) Pub. Date: Aug. 30, 2018

(54) GYMNASTIC EQUIPMENT

(71) Applicant: Marco DE ANGELIS, Cesena (IT)

(72) Inventor: Marco DE ANGELIS, Cesena (IT)

(21) Appl. No.: 15/553,471

(22) PCT Filed: Feb. 26, 2016
(86) PCT No.: PCT/IB2016/051079

§ 371 Date: Aug. 24, 2017

(30) Foreign Application Priority Data
Feb. 26, 2015 (IT) BO2015A000102

(51) Int. Cl. A63B 21/00; A61H 1/00; A63B 21/062; A63B 23/035; A63B 23/04; A63B 23/12

(52) U.S. Cl. CPC A63B 21/00178; A63B 2225/093; A63B 21/0628; A63B 21/4034; A63B 23/03541; A63B 21/4047; A63B 21/4035; A61H 1/001; A63B 23/0405; A63B 23/1209; A63B 23/1254; A63B 23/1281; A61H 2201/5043; A63B 2208/0228; A61H 1/005

(57) ABSTRACT

Gymnastic equipment includes a first element, which is fixed or movable, adapted to interact exclusively with a first portion of the user's body, a second element, which is fixed or movable, adapted to interact exclusively with a second portion of the user's body, the first portion and the second portion being arranged on opposite sides with respect to the sagittal plane of the user's body. The equipment further includes a first vibration generator associated to the first element, a second vibration generator associated to said second element, and a control unit to which the first vibration generator and the second vibration generator are operatively connected. The control unit of the gymnastic equipment includes an independent actuator of the first vibration generator and of the second vibration generator adapted for actuating the first and second vibration generators in respective first and second time periods alternating with each other in sequence and not overlapping.

### TECHNICAL FIELD OF THE INVENTION

The present invention concerns a gymnastic equipment.

In greater detail, the present invention concerns a gymnastic equipment suitable for generating and transmitting vibrations to the musculoskeletal system of the user.

### BACKGROUND ART

It has been found experimentally, in various scientific studies, that the transmission of vibrations with suitable characteristics to the musculoskeletal system of the user—i.e. with correctly defined direction, frequency, amplitude and duration—can have multiple beneficial effects like, for example, increased force, power (Sitjà-Rabert M et al. Disabil Rehabil. 2012), mass (Stewart V H et al. Scand J Med Sci Sports. 2014) and muscle tone, improvement of physical performance, better post-exercise recovery (Kosar A C et al. J Strength Cond Res. 2012), countering the occurrence of diseases like osteoporosis (Gómez-Cabello A et al. Sports Med. 2012), improvement of the peripheral blood circulation conditions, effectiveness of various kinds of post-operation rehabilitation, probably also loss of fatty mass (Cristi-Montero C et al. Nutr Hosp. 2013), and others still.

For some time, on the market there have been gymnastic equipment generically defined as vibrating, for the most part consisting of platforms.

Such apparatuses, in the platform type, normally comprise a base that supports a device for generating vibrations having frequency and amplitude features suitable for interaction with the human body.

In particular, the aforementioned device for generating vibrations is connected to an overlying platform, normally arranged horizontally, on which the user rests his/her feet in substantially upright position, preferably holding on to a suitable support.

The device for generating vibrations used in vibrating platforms can, for example, be of the mechanically actuated type commonly defined as eccentric, i.e. comprising an electric motor the outlet shaft of which is connected to at least one rotating element, having an axis of symmetry not coinciding with the rotation axis; such a rotating element is in turn connected to the platform on which the user stands.

The eccentric rotation of the rotating element therefore generates substantially vertical mechanical vibrations, with predetermined characteristics, which are directly transmitted to the lower limbs of the user when he/she is in standing position on the platform.

The considerations outlined above are fully valid for any type of equipment, irrespective of the way in which the vibrations are generated.

The device for generating vibrations used in vibrating platforms can also be of the electromagnetically actuated type, having an operating principle totally analogous to that of a loudspeaker for reproducing sounds.

In detail, this last type of device normally comprises a permanent magnet defining an air gap, inside which a coil of conductive material connected to a suitable electric power supply circuit is able to move.

The mobile coil is in turn mechanically coupled with the platform on which the user stands.

In short, by supplying the mobile coil with a current of suitable frequency, a substantially vertical vibration of the platform with the desired characteristics is obtained.

Whatever the way in which the vibration is generated, it is nevertheless possible to identify two types of vibrating platforms:

bilateral vibration, in which the interface vibrates in a substantially—totally or mainly—vertical direction with the two sides (right or left or front and rear) of the footboard lifting or lowering simultaneously;
alternately vibrating or oscillating in which the interface, built from a single platform that oscillates around a central axis or with two footboards (right/left or front/rear), vibrates in a substantially vertical direction with the two sides of the footboard (right-left or front-rear) lifting or lowering in phase opposition: one goes down when the other goes up and vice-versa.

The market has also proposed, in addition to vibrating platforms, other exercise apparatuses that transmit vibrations to parts of the user's body during exercise; for example, but not exclusively, such transmission of vibrations can take place at the upper limbs or at the lower limbs.

For example, these can be isometric apparatuses, or ones with guided movements, or with free movements (for example with cables connected to weights).

Known vibrating platforms, like other known apparatuses that use the transmission of vibrations to certain parts of the user's body during exercise, however, have substantial drawbacks that often result in them not being recommended or stop them from being used.

One of the main drawbacks of apparatuses that transmit vibrations concerns the fact that the vibrations are transmitted in a very short time period, in great quantity, and with great discomfort, to the entire body, reaching organs and systems that can be damaged thereby: skeletal, digestive, reproductive, visual and vestibular system (Abercromby A F et al. Med Sci Sports Exerc. 2007).

In particular, the propagation of the vibrations at the cervical and cranial level is perceived as annoying.

This drawback substantially limits the potential of the device, since the user—even if not suffering from particular pathologies—can only exercise for limited time periods, unless he/she is willing to put up with discomfort that are sometimes intolerable.

The considerations outlined above thus also apply for other exercise apparatuses different from vibrating platforms; for example, apparatuses that involve the use of the upper limbs risk being potentially even more harmful, because when they are used the vibrations generated can reach the user's head even more quickly and easily.

The main reason for discomfort and the risks of using vibrations applied according to the methods currently in use, consists of the fact that the solutions proposed up to now involve continuous vibration, in phase or counterphase, bilateral, mainly of both limbs (lower or upper), simultaneously for a number of minutes or fractions of a minute.

The bilateral vibration thus generated (simultaneously on both limbs, upper or lower) results in extremely unpleasant effects, negative effects, risks of harm to various parts of the body of the user, including, for example:
extremely annoying vibration felt at the cranium and the cervical spine after a very short time (in general of the order of 1 second) after the start of the vibration;
risks to the spine, in the lumbar and cervical sections;
osteoporotic vertebrae, with possibility of fractures, etc.;
the brain, in the cerebral and vascular component;
the ear, in the vestibular component;
the eye, at the retina and lens;
prolonged isometric contraction of both of the limbs without action of the “muscle pump” on venous and lymphatic circulation, which thus causes a stasis of the two liquids.

The unwanted effects and the risks are also more evident in the case in which both of the limbs subjected to vibration simultaneously (upper or lower) are in mechanical conditions such as to promote greater transmission of the vibration: more open angles (e.g. extended knees and hips), muscle contraction that locks the limbs to the torso and the bones in sequence with each other.

These aspects thus make the use of this type of equipment very uncomfortable and potentially very risky, and this not recommended, in particular for certain populations, especially for children and the elderly.

All of the unwanted effects and the risks of these types of vibrating equipment are due to the fact that the vibrations transmitted to both of the limbs are propagated to both halves (right and left) of the body, joining together and reinforcing each another (also by resonance phenomena) in the torso, in the axial structures and in the sagittal planes of symmetry, where the risks of damage are therefore amplified at the spine (lumbar and cervical), the cranium and its content (brain and eye structures).

Since the vibration is continuous for many seconds, resonance phenomena can also be created (inside the rigid body structures) which will further amplify the vibration energy at structures close to the central axis or sagittal plane.

### AIMS OF THE INVENTION

The technical task of the present invention is therefore to improve the state of the art.

In such a technical task, an aim of the present invention is to devise a gymnastic equipment that makes it possible to eliminate, or at least decisively reduce, the effects of transmissions of vibrations to unwanted parts of the body, such as the spinal column, head, and others.

Another aim of the present invention is to provide a gymnastic equipment that can make physical exercise accompanied by the transmission of vibrations to parts of the body involved in the exercise itself more comfortable, and thus able to be done in nicer conditions.

A further aim of the present invention is to devise a gymnastic equipment that makes it possible to more effectively reach the muscle-skeletal structures involved in the exercise with transmission of vibrations.

Such a task and such aims are all accomplished by the gymnastic equipment according to the attached claim 1 and based on the biomechanical considerations described below.

The human body normally undergoes stresses that generate vibrations of enormous energy during walking and even more during running, but these stresses last a very short time (generally much less than one second), and therefore not able to generate transmission to the rest of the body or phenomena of resonance along the rigid body structures. Moreover, they are always generated on only one hemisoma at a time.

The term “hemisoma”, in the rest of the present description, means one of the two halves of the human body, defined, as is commonplace in anatomy, according to a sagittal plane of symmetry.

In this way, the vibration energy propagated towards the torso is normally dispersed before pervading the entire body, particularly thanks to its diffusion and dispersion in the other hemisoma without creating damage to the central structures.

In the next step, walking or running, the mechanical stress reaches the other hemisoma and the propagation of the energy follows the reverse path, becoming dispersed once again without causing damage, indeed contributing to keeping the bone structure healthy.

The solution that is proposed, in order to have the bone and muscle benefits of the vibrations without the risks up to now connected to the use of apparatuses generating vibrations (and, last but not least, with the advantage of promoting the beneficial effect of the intervention of the “muscle pump” on venous and lymphatic circulation by the alternation of phases of intense contractions with phases of minimum contractions or of actual relaxation), therefore consists of generating, and transmitting, vibrations on one hemisoma at a time, giving time for the vibration wave to disperse in the other hemisoma, not simultaneously subjected to vibration stresses.

In this way, a mechanical stress model generating vibrations similar to that naturally followed by more common human activities, such as walking and running, would be reproduced.

In the literature, indeed, it has been demonstrated that the vibration of a single foot determines the reduction of the doses of vibrations and the acceleration of the head (Abercromby A F et al. Med Sci Sport Exerc. 2007).

According to the solution proposed here, the part of the body in contact with the vibrating structure must therefore be just one hemisoma (most commonly the part of an upper limb, like, for example, a hand, or of a lower limb, like, for example, a foot) at a time.

The two hemisomas are thus both subjected to vibrations but in periods alternating in succession and not simultaneous.

The vibration therefore acts on each hemisoma for periods lasting a very short time, typically less than 3 seconds (e.g. 0.5 s), so as to fully stress all of the bone, muscle and nervous structures, rapidly dispersing in the rest of the body and being absorbed in the other hemisoma before having the typical negative effects and the risks of central compounding with a vibration coming from the other hemisoma (opposite foot or hand).

The short, period of the vibration avoids the diffusion with resonance, and therefore with negative effects, on all of the delicate and sensitive structures of the body, as would happen, however, even with limited vibrations at a single limb but for a long time.

According to the invention, the vibration on the other hemisoma is thus applied according to a time phase shift, with:

a) zero overlap, starting at the same moment at which the previous one, on the other side, ends;
b) a free interval, more or less short (for example of the order of tens of ms).

In this way, it is also possible to apply vibrations of greater energy without running the risk of causing damage to the body, as would happen with high powers transferred to both hemisomas.

The gymnastic equipment according to the invention, suitable for operating according to the concepts outlined earlier, comprises a first element, fixed or movable, adapted for interacting with a first portion of the user's body, and a second element, fixed or movable, adapted for interacting with a second portion of the user's body.

The aforementioned first portion and second portion of the user's body are thus arranged at respectively opposite sides with respect to the sagittal plane of the user's body.

In other words, the first portion and the second portion respectively belong to the first hemisoma and to the second emisoma of the user's body.

The equipment also comprises first vibration generating means associated with the first element, and second vibration generating means associated with the second element, as well as a control unit to which the first and the second vibration generating means are operatively connected.

According to an aspect of the invention, the control unit comprises independent actuation means of the first vibration generating means and of the second vibration generating means, adapted for actuating the first means and the second means in respective first and second time intervals alternating with each other in sequence and not overlapping.

Basically, according to the invention, the vibrations transmitted to the two distinct portions of the body are:
alternating in sequence without intermediate time interval, or with intermediate time interval less than or equal to 2 seconds;
of short or very short duration, in any case less than or equal to 3 seconds.

The dependent claims refer to preferred and advantageous embodiments of the invention, i.e. the vibrating platforms and all of the other exercise apparatuses that transmit vibrations to parts of the user's body, when inactive or during exercise; for example, but not exclusively, such transmission of vibrations can take place at the upper limbs or the lower limbs, through isometric apparatuses, or with guided movements, or with free movements (for example with cables connected to weights or resistances).

### BRIEF DESCRIPTION OF THE DRAWINGS

These and further advantages will become clearer to those skilled in the art from the following description and from the attached drawings, given as a non-limiting example, in which:

FIG. 1 is a schematic perspective view of a gymnastic equipment according to the invention;

FIG. 2 is a detailed perspective view of the equipment, with some parts removed for the sake of clarity;

FIG. 3 is a functional diagram of the equipment according to the invention;

FIG. 4 is a graph illustrating the vibrations generated by the equipment according to the invention in a generic physical exercise time period, and applied respectively to a first portion and to a second portion of the user's body;

FIG. 4A is a graph illustrating the vibrations generated by the equipment according to the invention in a generic physical exercise time period, and applied respectively to a first portion and to a second portion of the user's body, according to another embodiment of the invention;

FIG. 4B is a graph illustrating the vibrations generated by the equipment according to the invention in a generic physical exercise time period, and applied respectively to a first portion and to a second portion of the user's body, according to yet another embodiment of the invention;

FIG. 5 is a perspective view of the gymnastic equipment according to another embodiment of the invention;

FIG. 6 is a detailed perspective view, with some parts removed for the sake of greater clarity, of the gymnastic equipment of FIG. 5;

FIG. 7 is a perspective view of the gymnastic equipment according to yet another embodiment of the invention;

FIG. 8 is a perspective view of the gymnastic equipment according to a further embodiment of the invention;

FIG. 9 is another perspective view, from a different angle, of the equipment of FIG. 8;

FIG. 10 is a front perspective view of the gymnastic equipment according to another embodiment of the invention;

FIG. 11 is a rear perspective view of the gymnastic equipment of FIG. 10;

FIG. 12 is a front perspective view of the gymnastic equipment according to yet another embodiment of the invention;

FIG. 13 is a rear perspective view of the gymnastic equipment of FIG. 12;

FIG. 14 is a schematic front view of a user using a gymnastic equipment according to the current state of the art with two limbs subjected to simultaneous vibration;

FIG. 15 is a schematic front view of a user using a gymnastic equipment according to the present invention, with dispersion before amplification due to resonance;

FIG. 16 is a graph illustrating the vibrations generated by the equipment according to the invention in a generic physical exercise time period, and applied respectively to a first portion and to a second portion of the user's body, according to another embodiment of the invention;

FIG. 17 is a graph illustrating the vibrations generated by the equipment according to the invention in a generic physical exercise time period, and applied respectively to a first portion and to a second portion of the user's body, according to yet another embodiment of the invention.

### EMBODIMENTS OF THE INVENTION

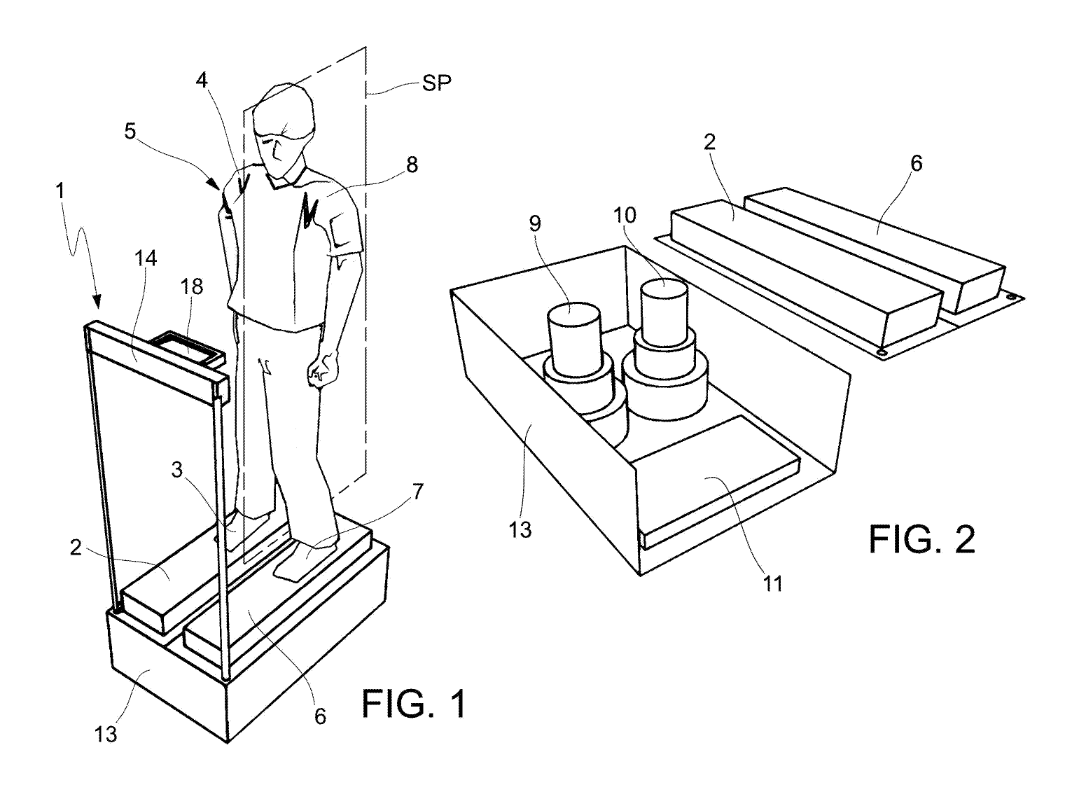

With reference to FIG. 1, a gymnastic equipment according to the present invention is wholly indicated with 1.

The gymnastic equipment according to the invention, as made clearer hereinafter, can, without distinction, be of the so-called isometric type, in which the muscle exercise takes place without actual movement of the limbs or of parts or elements of the equipment connected to them, or for example of the isoinertial type (with weights or flywheels), and/or auxotonic type (with elastic, or with resistances however generated, in which the muscle exercise takes place through the movement of the limbs or other parts of the body), or even with guided movements or with free movements (for example with cables connected to weights or resistances).

The gymnastic equipment 1 comprises a first element 2.

The first element 2 can be fixed or movable.

The first element 2 is adapted for interacting with a first portion 3 of the user's body 5.

As will become clearer hereinafter, the aforementioned first portion 3 can be any portion, without any limitation.

The gymnastic equipment 1 also comprises a second element 6.

The second element 6 can be fixed or movable.

The second element 6 is adapted to interact with a second portion 7 of the user's body 5.

The second portion 7 of the body can also be any portion, without any limitation.

The first portion 3 and the second portion 7 of the user's body are arranged on opposite sides with respect to the sagittal plane SP of the user's body 5.

In other words, the first portion 3 and the second portion 7 respectively belong to the first hemisoma 4 and to the second hemisoma 8 of the user's body 5 (as shown in FIG. 1).

The equipment 1 also comprises first vibration generating means 9.

The first vibration generating means 9 are associated with the first element 2, according to the ways made clearer hereinafter.

The equipment 1 further comprises second vibration generating means 10.

The second vibration generating means 10 are associated with the second element 6, according to the ways made clearer hereinafter.

The gymnastic equipment 1 comprises a control unit 11.

The control unit 11 is operatively connected to the first vibration generating means 9 and to the second vibration generating means 10.

According to an aspect of the present invention, the control unit 11 comprises independent actuation means 12 of the first vibration generating means 9 and of the second vibration generating means 10.

The aforementioned independent actuation means 12 are adapted for actuating the first vibration generating means 9 and the second vibration generating means 10 in respective first and second time periods T1,T2 alternating with each other in sequence and not overlapping.

As will become clearer hereinafter, thanks to this solution the transmission of the vibrations generated by the equipment 1 always and only takes place at only one of the portions 3,7 of the user's body 5.

In other words, the equipment 1, at every moment of exercise, can transmit vibrations, with various modes of amplitude and frequency, directly at only one of the portions 3,7 of the user's body 5, whereas the other portion 3,7 is not subjected to direct transmission of the vibrations themselves, also in the case in which it is possibly in contact with the respective first or second element 2,6 of the equipment 1 itself.

In this way, the portion 3,7 not involved in the direct transmission of vibrations contributes to the quick and effective damping thereof, preventing them from reaching areas in which they are unwanted or in which they could be potentially harmful, such as the spinal column and the head of the user 5 (sensitive central structures), if added to vibrations transmitted on the other portion 3,7.

At the same time, however, the vibrations transmitted to the first or second portion 3,7 of the user's body 5, on the other hand, are fully effective for the muscle-skeletal structures involved, also because being able to avoid the discomfort and the risks connected to bilateral mode of administration, with the present monolateral mode it is possible to apply much greater powers, in an innocuous but more effective manner.

The transmission of vibrations to just one of the portions 3,7 of the user's body 5 is also much more focused in the treatment of the muscle-skeletal structures involved, with less dispersion of energy also thanks to the fact that the user 5 can better concentrate on the exercise of a single portion 3,7 of the body rather than both, helping the natural nervous control system of the two hemisomas, which are normally activated according to the neurological principle of contralateral interneuron inhibition (Hanna-Boutros et al. J Neurophysiol. 2014).

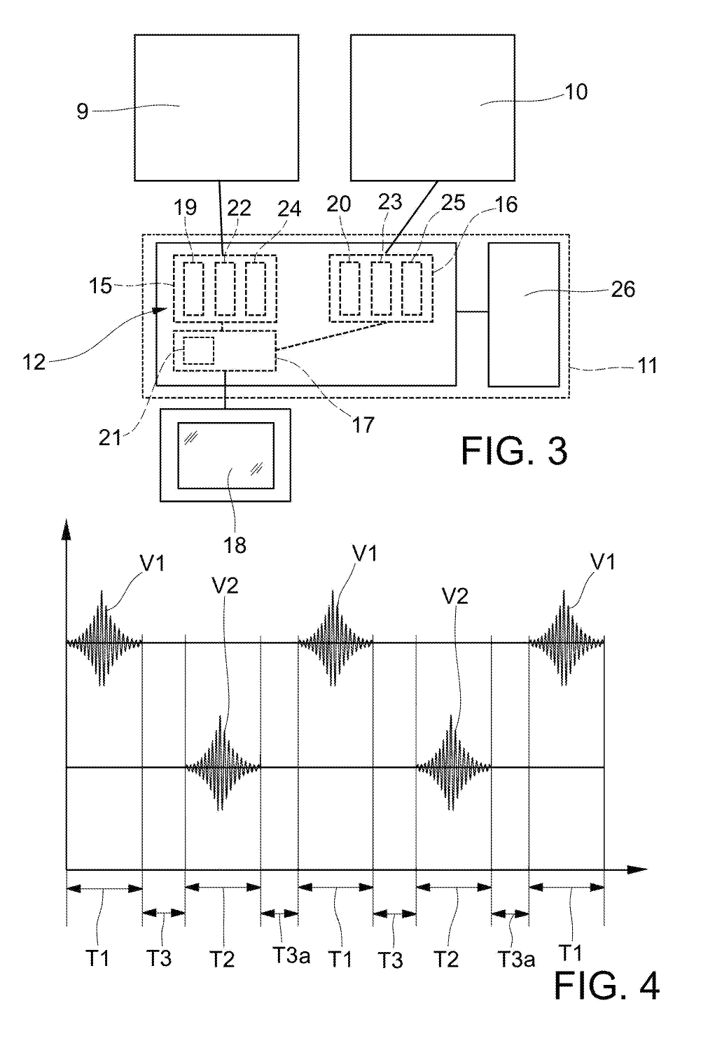

In the embodiment of the invention illustrated in FIGS. 1-4, the gymnastic equipment 1, as an example, consists of a vibrating platform.

In this embodiment, therefore, the first element 2 and the second element 6 of the equipment 1 are fixed, and comprise respective support plates arranged substantially horizontally.

The support plates of the first element 2 and of the second element 6 are independent and separate from one another, in other words there is no mechanical connection between the support plate of the first element 2 and that of the second element 6.

As shown in FIG. 1, therefore, the first portion 3 and the second portion 7 of the user's body 5, in this case, consist respectively of the first foot and the second foot thereof.

In detail, the equipment 1 comprises a support frame 13, with which the first element 2 and the second element 6 are associated so as to be able to be vertically mobile.

The equipment 1 also comprises a support portion 14 associated with the frame 13, which the user 5 can grip to stay balanced during exercise.

More specifically, the support frame 13 for example has a substantially box-like configuration, and houses the first and the second vibration generating means 9,10, as well as the control unit 11, inside it.

The configuration of the support frame 13 illustrated in FIG. 1, as well as the arrangement of the components of the equipment 1 inside it, is merely a non-limiting example.

According to another aspect of the invention, the independent actuation means 12 comprise a first local management unit 15 of the first vibration generating means 9.

Moreover, the independent actuation means 12 comprise a second local management unit 16 of the second vibration generating means 10.

The first local unit 15 and the second local unit 16 are operatively slaved to a single supervision unit 17.

The supervision unit 17 is in turn operatively connected to an interface 18, through which the user 5 can set and/or control the operating parameters of the equipment 1.

The interface 18 can, for example, be associated with the support portion 14, or with other parts of the equipment 1.

According to yet another aspect of the invention, the first local unit 15 comprises respective first adjusting means 19 of the first time period T1 of the vibration produced by the first generation means 9 during exercise.

Moreover, the second local unit 16 comprises respective second adjusting means 20 of the second time period T2 of the vibration produced by the second generation means 10.

This means that the first local unit 15 and the second local unit 16 are capable of autonomously managing, respectively, the duration of the first time period T1 in which the first vibration generating means 9 act, and of the second time period T2 in which the second vibration generating means 10 act; according to predetermined exercise programs, for example set by the user 5 or by the trainer, physiotherapist, or other trained person.

As stated, in an embodiment of the invention the first time period T1 and the second time period T2 never overlap.

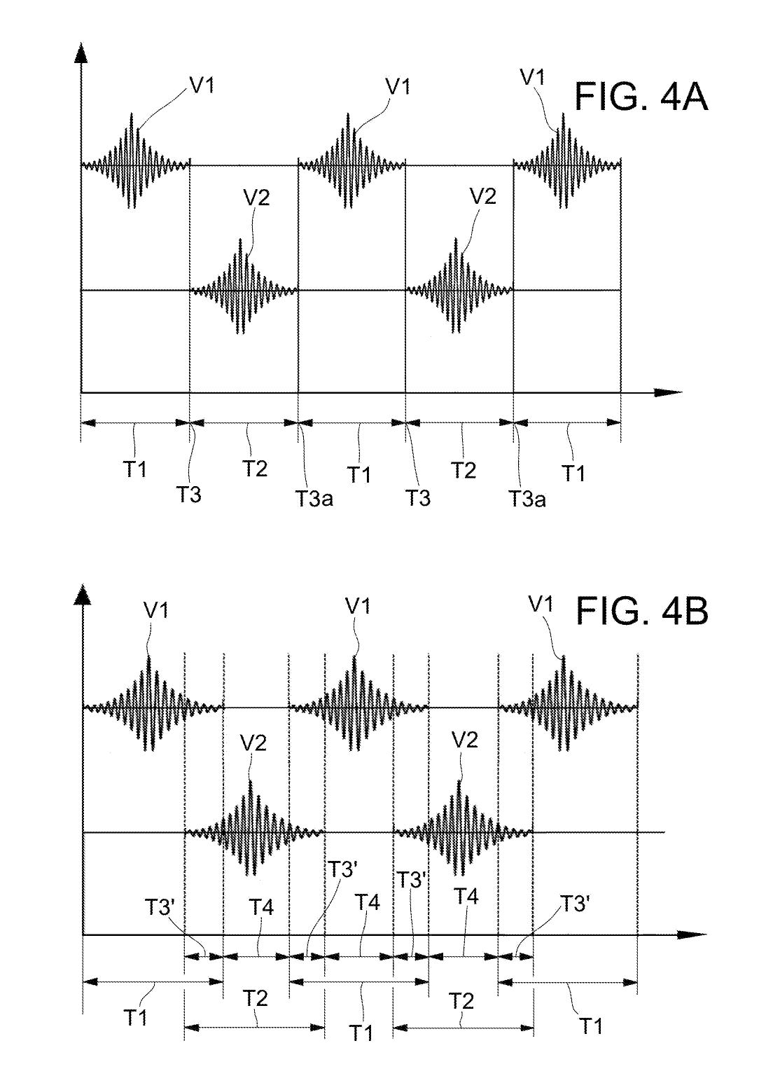

To better understand, please refer to FIG. 4, in which the vibrations V1 generated respectively by the first generation means 9, and the vibrations V2 generated by the second generation means 10 are schematically represented, as a function of time.

As can be observed, in a generic exercise time period, the first generation means 9 and the second generation means 10 act alternately, and in succession after one another, without any overlapping.

Between the first time period T1, in which the first generation means 9 act, and the second time period T2, in which the second vibration means 10 act, two intermediate time intervals T3,T3a are respectively provided, in which neither of the means 9,10 acts.

This mode, which ensures the complete dissipation of the vibration energy transmitted to a portion 3,7 before the start of the transmission of new vibration energy to the other portion 3,7, is certainly preferable in cases in which it is intended to entirely eliminate both the discomfort and the risks connected to the negative effects of vibrations on the structures (muscle-skeletal or organs) arranged in the sagittal plane of symmetry (sensitive central structures).

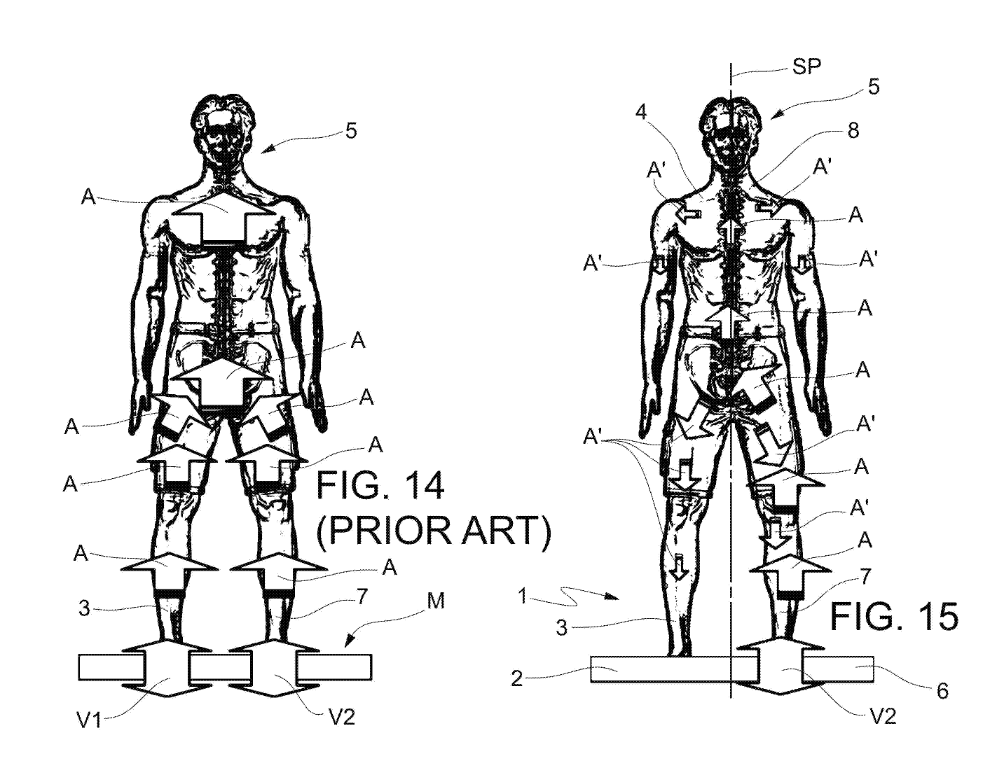

The advantages illustrated above will become clearer from the schematic representations of FIGS. 14,15.

FIG. 14 schematically shows a user 5 that uses a conventional gymnastic equipment M, i.e. according to the current state of the art (in particular a vibrating platform).

As can be seen, the equipment M, which generates a bilateral vibration V1,V2, transmits direct vibrations A to both portions 3,7 of the user's body 5, in this case the lower limbs.

The direct vibrations A propagate along the limbs and add together at the spinal column, and from here quickly reach the cranial area, and/or other sensitive central structures (in an amplified manner).

FIG. 15, on the other hand, schematically shows a user 5 using a gymnastic equipment 1 according to the present invention.

In this case, at a certain moment (or in a certain operating time period of the equipment) only one of the first and second element 2,6 of the equipment 1 generates vibrations V1,V2, and thus transmits direct vibrations A to one of the portions 3,7 of the user's body separated by the sagittal plane SP.

As can be seen, as a consequence of this, only a minimal part of the direct vibrations A reaches the cranial area (or possibly other particularly sensitive areas of the body): indeed, a substantial fraction A′ of the direct vibrations A, during the intermediate time period T3,T3a, propagates through other parts of the body, and is consequently absorbed, becoming substantially innocuous.

It should be noted that the use of vibrations on a single limb, but prolonged over time (for example for a few minutes), would still have amplification and resonance effects such as to certainly cause uncomfortable and harmful consequences on the rest of the body.

According to another aspect of the invention, the control unit 11—and in particular the supervision unit 17 comprises means 21 for varying the intermediate time intervals T3,T3a that occur between the first and second time periods T1,T2.

Such intermediate time intervals T3,T3a can be set to any values specifically calculated and compatible with the type of exercise performed.

The intermediate time intervals T3,T3a respectively comprised between the first time period T1 and the second time period T2, and then between the second time period T2 and the next time period T1, can be of the same duration, or of different duration.

For example, a different duration of the aforementioned intermediate time intervals T3,T3a can be foreseen in the case in which it is intended to obtain greater dispersion of the vibrations along a certain portion 3,7 of the body with respect to another.

This can be advantageous in the case in which the two portions 3,7 of the body that undergo the transmission of vibrations must be treated differently from one another, for different reasons.

According to an aspect of the present invention, each intermediate time interval T3,T3a has a value of less than 2 seconds.

In an embodiment of the invention, each intermediate time interval T3,T3a has a value roughly equal to 2 seconds.

In an embodiment of the invention, each intermediate time interval T3,T3a has a value exactly equal to 2 seconds.

They are time periods suitable for allowing the dispersion of the vibrations V1,V2 generated by the equipment through the user's body 5.

The first time period T1 and the second time period T2 can have identical values, or they can be assigned different values if, for whatever reason, the user 5 wishes to exert one portion 3,7 of the body more than the other, or in any case differently from the other.

According to an aspect of the invention, the first time period T1 and the second time period T2 have respective values of less than 3 seconds.

In an embodiment of the invention, the first time period T1 and the second time period T2 both have a value roughly equal to 3 seconds.

In an embodiment of the invention, the first time period T1 and the second time period T2 both have a value exactly equal to 3 seconds.

The first local unit 15 and the second local unit 16 also comprise respective first selecting means 22 of the frequency of the vibration produced by said first generation means 9, and second selecting means 23 of the frequency of the vibration produced by said second generation means 10.

The first local unit 15 and the second local unit 16 also comprise respective first selecting means 24 of the amplitude of the vibration produced by said first generation means 9, and second selecting means 25 of the amplitude of the vibration produced by said second generation means 10.

Thus, the first vibration generating means 9 and the second vibration generating means 10 can operate at identical frequencies and amplitudes, or even at different frequencies and/or amplitudes in the case in which the specific training/exercise devised for the user requires it, without any limitation.

The control unit 11 comprises—or is associated with—electrical power supply means 26 and/or other known components, necessary for the correct operation of the gymnastic equipment 1 and not described in detail.

The first vibration generating means 9 and the second vibration generating means 10 can be of the mechanical type, for example eccentric.

Or, in a totally equivalent manner, the first vibration generating means 9 and the second vibration generating means 10 can be of the electromagnetically actuated type.

The choice of one or other type of actuation, or of yet another type that may be known and available on the market, is linked exclusively to the satisfaction of specific application requirements and/or to obtaining certain behaviours of the equipment 1 during its operation, and does not constitute any limitation to the purposes and effects of the present invention.

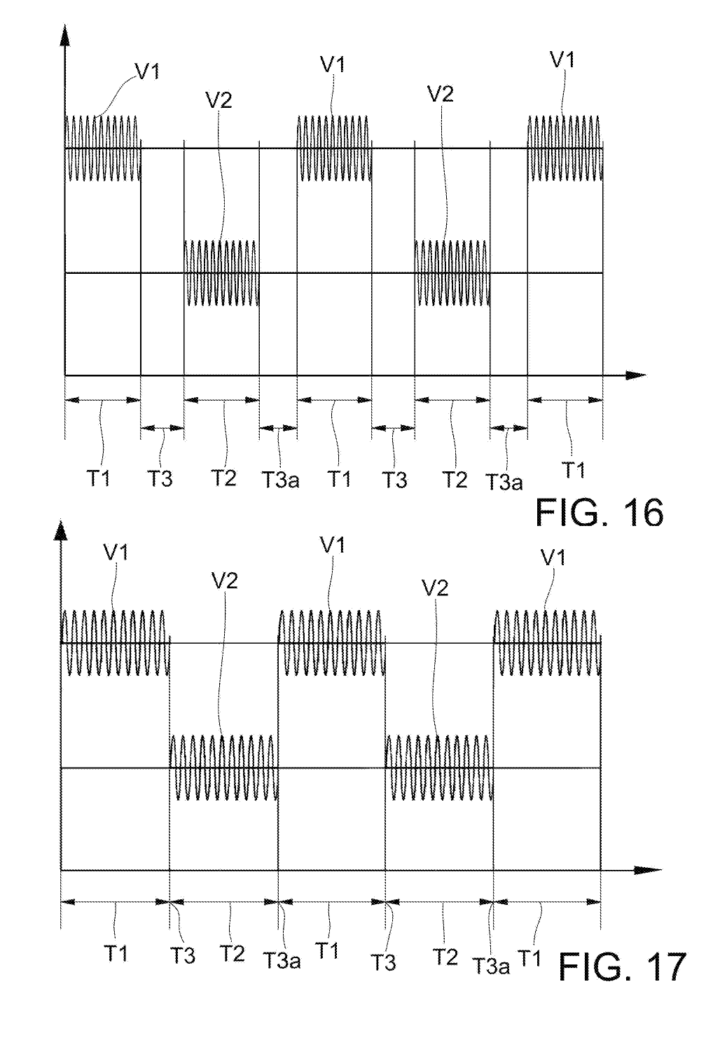

FIGS. 15 and 16 are graphs that illustrate, totally schematically and for the purposes of better understanding, the vibrations V1,V2 generated by the equipment 1 according to the invention in a generic physical exercise time period, and applied respectively to a first portion and to a second portion of the user's body, in an embodiment of the invention in which the generation of vibrations V1,V2 takes place through electromagnetic means.

In particular, FIG. 16 refers to the case in which the intermediate time intervals T3,T3a have zero value.

Unlike what happens with mechanical actuation systems, in this case the vibrations V1,V2 are generated with quite sudden appearance.

The operation of the equipment 1 according to the invention, in light of what is described, is totally intuitive.

The user 5 positions the first portion 3 and the second portion 7 of the body—i.e., in the embodiment of FIGS. 1-4, the first foot and the second foot—respectively on the first element 2 and on the second element 6 of the equipment 1.

After having set the operating parameters through the interface 18, the user 5 starts the equipment 1.

As shown schematically in FIG. 4, the independent actuation means 12 of the control unit 11 manage the operation of the first generation means 9 and of the second generation means 10 so that they autonomously generate vibrations, of desired amplitude and frequency, respectively in first time periods T1 and second time periods T2 more or less regularly, or totally irregularly, alternating, spaced by intermediate time intervals T3,T3a of predetermined duration, in any case so as to never overlap.

The operation described, as stated, makes it possible to transmit, at every moment of exercise, the vibrations generated by the equipment 1 only to a portion 3,7 of the user's body 5, thus leaving the other free so that it contributes to damping the vibrations to prevent them from being transmitted, particularly, to the spinal column and to the head.

The operating parameters of the first and second vibration generating means 9,10 are independently adjustable with wide freedom, to satisfy specific operating requirements, for example to stress the first portion 3 and the second portion 7 of the user's body 5 differently.

The equipment 1 according to the invention can also be set in an operating condition in which only the first vibration generating means 9 or only the second vibration generating means 10 are operative, whereas the others are deactivated, so as to stress exclusively one portion 3,7 of the user's body 5.

This operating condition can be particularly recommended, for example, for rehabilitation therapy.

As stated, however, the time periods in which the vibrations V1,V2 are generated must be short, at most of the order of a few seconds, separated by intermediate stopping periods.

According to another embodiment of the invention, and with reference in this case to FIG. 4A, between the first time period T1, in which the first generation means 9 act, and the second time period T2, in which the second generation means 10 act, there is zero intermediate time interval T3.

In other words, at the same moment at which the vibration produced by the first generation means 9 stops, the vibration produced by the second generation means 10 starts.

Therefore, there is no overlapping between the first time period T1 and the second time period T2.

According to yet another embodiment of the invention, and with reference to FIG. 4B, between the first time period T1, in which the first generation means 9 act, and the second time period T2, in which the second generation means 10 act, there is a negative intermediate time interval T3′.

In other words, the first time period T1, in which the first generation means 9 act, and the second time period T2, in which the second generation means 10 act, partially overlap in time: T3′ thus represents the overlapping time period between the first time period T1 and the second time period T2.

Preferably, but not exclusively, T3′ is less than T1/2 and/or than T2/2.

Even more preferably, T3′ is less both than T1/2 and than T2/2.

This means that, during the administration of the vibrations by the equipment 1, further time periods are identified, indicated with T4 in FIG. 4B, during which only the first generation means 9 or the second generation means 10 are active, or during which there is no operative overlapping between the first generation means 9 and the second generation means 10.

This relationship mode between the two time periods (partial overlapping) can be used, for example, preferably when it is not necessary to completely cancel out the effect on one hemisoma and in fact it is wished to have partial adding centrally of the vibration energy, if not unwanted and not risky, to enhance the effect on the structures arranged at the sagittal plane of symmetry.

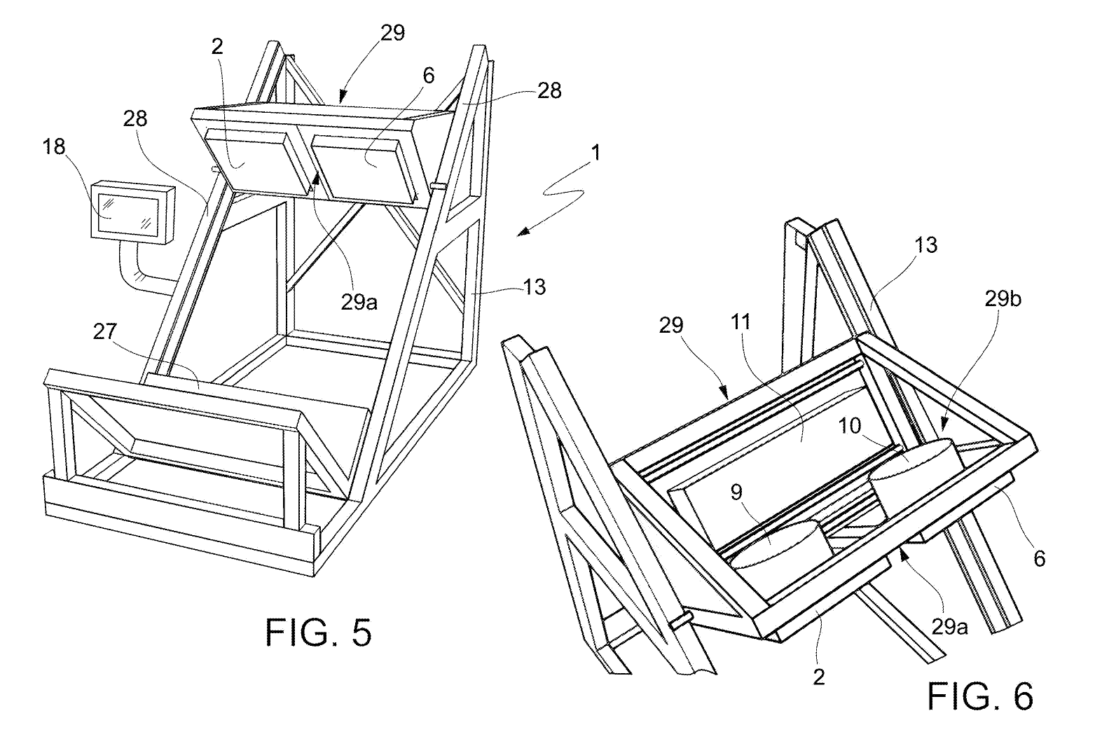

Another embodiment of the gymnastic equipment 1 according to the invention is illustrated in FIGS. 5,6.

In this embodiment, the gymnastic equipment 1 consists of a so-called “leg press”, i.e. a equipment through which the user carries out extension exercises of the legs.

The equipment comprises a support frame 13 comprising a base at which there is a seat 27 for the user, and an upper portion defining inclined guides 28, with which a carriage 29 is associated.

The carriage 29 is normally mobile along the inclined guides 28 to allow the extension of the user's legs, but in some particular embodiments of the present invention the carriage 29 could be blocked with respect to the inclined guides 28, so as to allow the user to carry out isometric exercises.

The carriage 29 can be associated with weights, not illustrated, so as to obtain the desired resistant action to the extension of the user's legs.

According to the invention, the carriage 29 comprises a first element 2 and a second element 6, adapted to interact respectively with a first portion 3 and a second portion 7 of the user's body, i.e. in particular his/her feet.

The first element 2 and the second element 6 are provided side-by-side on a suitable surface 29a of the carriage 29, a surface 29a that substantially faces the seat 27.

The first element 2 and the second element 6 are associated with the carriage 29 so as to be able to be mobile with respect to it, for example in a direction perpendicular or substantially perpendicular to the surface 29a.

As illustrated in particular in FIG. 6, the first element 2 and the second element 6 are respectively associated with first vibration generating means 9 and with second vibration generating means 10.

The first vibration generating means 9 and the second vibration generating means 10 are, for example, housed inside a suitable space 29b provided in the carriage 29, just like the control unit 11 of the equipment 1.

The interface 18 can be positioned in an area easy for the user to access, for example along inclined guides 28.

The operation of the gymnastic equipment 1 according to the present embodiment is totally analogous to that described for the previous embodiment of FIGS. 1-4, or even 4A,4B, with particular reference to the mode of production of the vibrations through the first and second generation means 9,10.

In this case, however, the user carries out a leg press against a resistant load, or against a blocked surface, i.e. isometrically.

During the leg press exercise, the first generation means 9 and the second generation means 10 produce alternate vibrations of predetermined duration that are transmitted directly to the first portion 3 and to the second portion 7 of the user's body 5, during respective first and second time periods T1,T2 that never overlap, and which are possibly separated by predetermined intermediate time intervals T3,T3a.

It should be specified that, in another embodiment of the equipment 1 according to the invention not illustrated in the figures, the carriage 29 could be sliding on non-inclined guides, but that instead are horizontal.

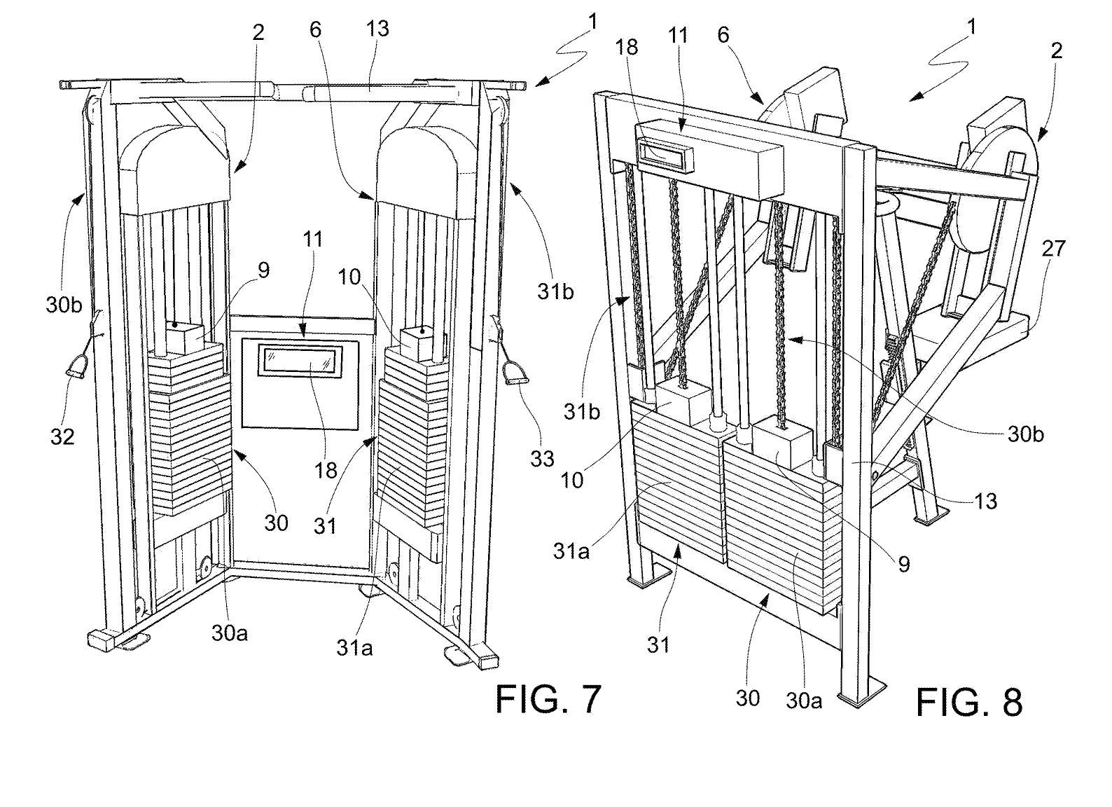

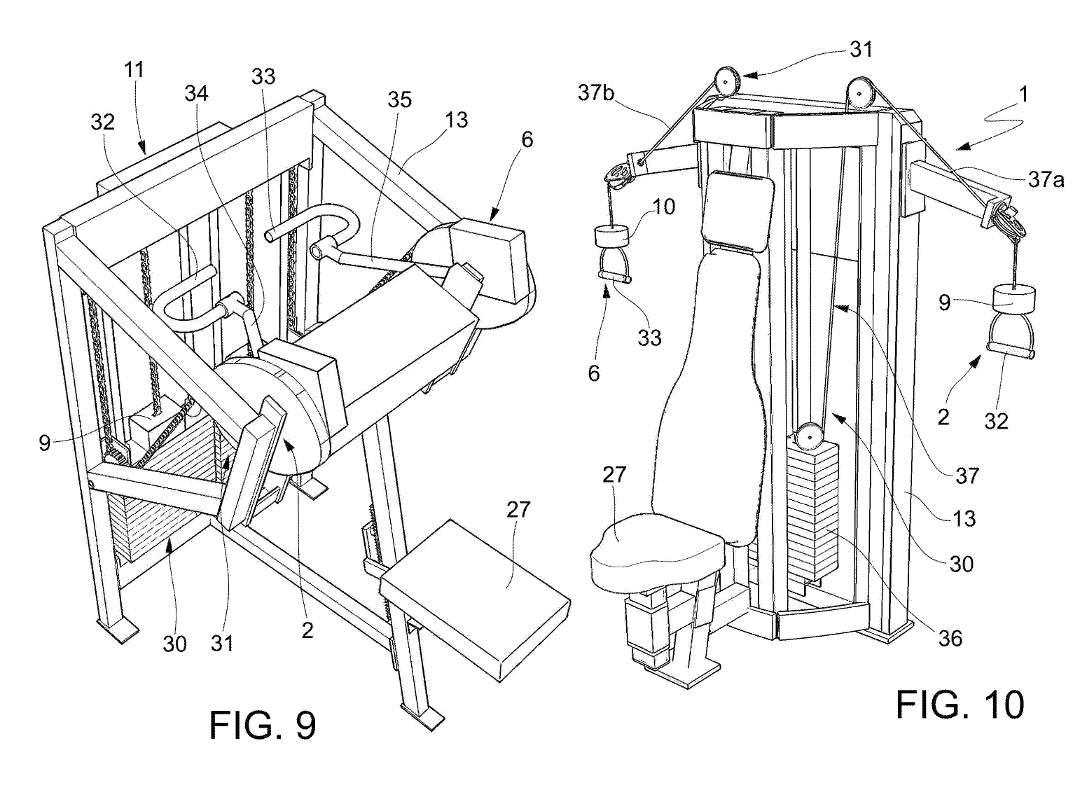

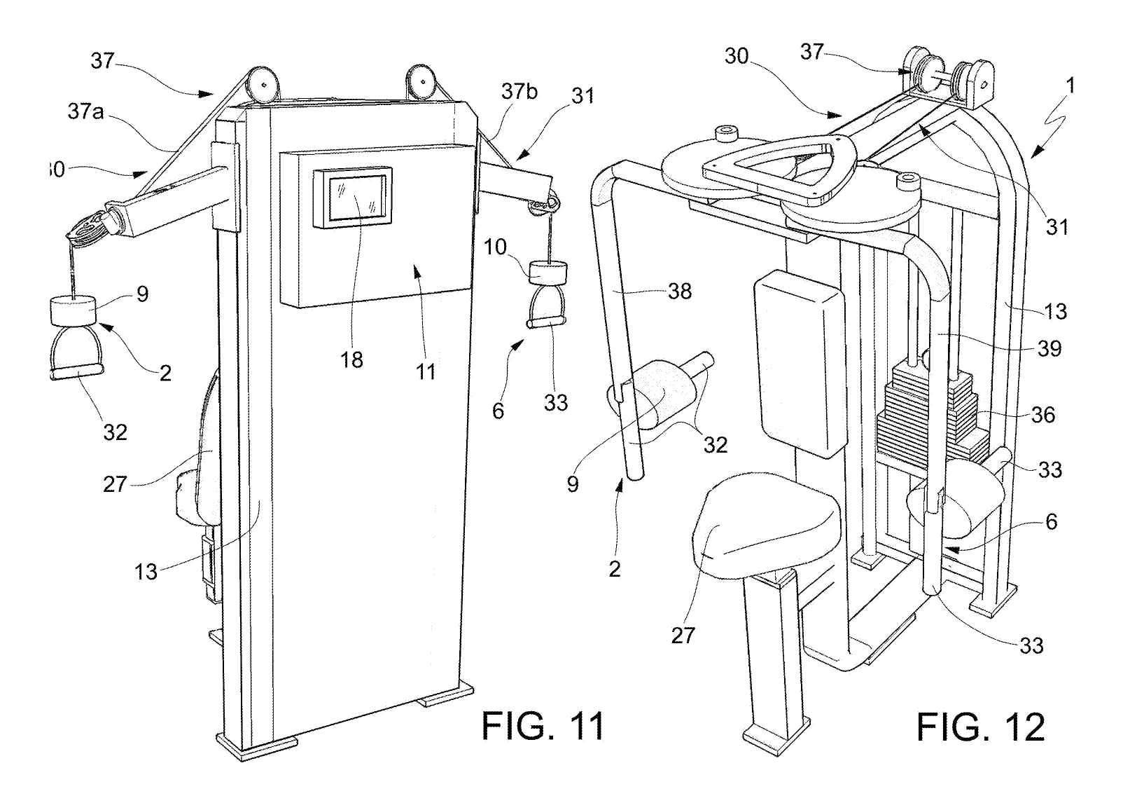

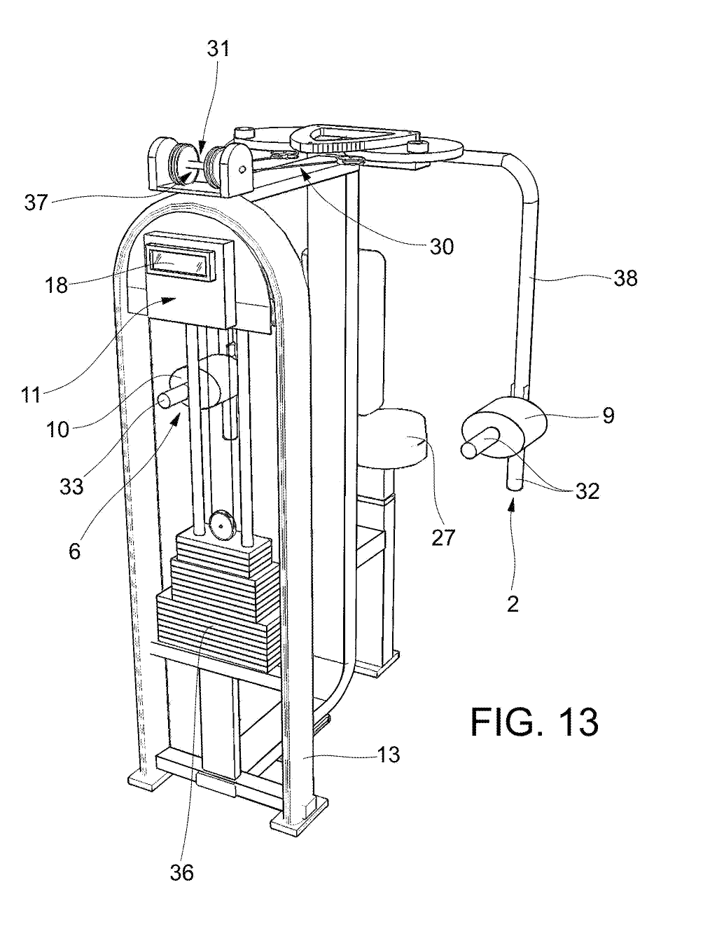

Another embodiment of the gymnastic equipment 1 according to the present invention is illustrated in FIG. 7.

In this embodiment, the gymnastic equipment 1 is of the so-called “adjustable pulley” type, i.e. a equipment for exercising the upper and/or lower limbs through lifting of weights with rope-sheave systems, according to free and independent trajectories for the first portion 3 and the second portion 7 of the user's body 5.

In-greater detail, the equipment 1 comprises a support frame 13 with which a first element 2 and a second element 6 are associated.

The first element 2 and the second element 6 are mobile and comprise respective first resistant means 30 and second resistant means 31.

As stated, the first resistant means 30 and second resistant means 31 respectively comprise a first weight stack 30a and a second weight stack 31a, slidably associated with the frame 13.

The first resistant means 30 and the second resistant means 31 also respectively comprise a first rope-sheave system 30b and a second rope-sheave system 31b, through which the first weight stack 30a and the second weight stack 31a can be raised by the user 5.

The first rope-sheave system 30b and the second rope-sheave system 31b can be adjusted, independently from one another, so as to take the respective first and second grips 32,33 to the desired height to carry out various kinds of exercises.

According to an aspect of this embodiment of the invention, the first vibration generating means 9 and the second vibration generating means 10 of the gymnastic equipment 1 are respectively connected to the first weight stack 30a and to the second weight stack 31a.

For example, the first vibration generating means 9 and the second vibration generating means 10 can be connected to the upper weights of each of the packs 30a,31a.

In this embodiment, the first vibration generating means 9 and the second vibration generating means 10 can preferably be of the mechanical type, for example eccentric.

During exercise, and thus during the lifting of the weight stacks 30a,31a with the upper or lower limbs, the first vibration generating means 9 and the second vibration generating means 10 operate according to the methods already described for the previous embodiments.

The user can thus carry out weight lifting exercises, according to free trajectories, subjecting distinct portions 3,7 of the body, for example the upper or lower limbs, to alternate vibrations.

According to an alternative operating mode, the user can exercise by subjecting only one of the portions 3,7 of the body to vibrations, for example in the case of rehabilitation therapy.

Yet another embodiment of the gymnastic equipment 1 according to the invention is illustrated in FIGS. 8,9.

In this embodiment, the gymnastic equipment 1 is of the type suitable for exercising the upper limbs, in particular the biceps muscle groups.

This is an equipment in which the movements of the upper limbs take place according to guided trajectories, and not free like in the case of the previous embodiment.

The equipment 1 comprises a support frame 13 and a seat 27.

The equipment 1 comprises a first element 2 and a second element 6, respectively suitable for interacting with a first portion 3 and with a second portion 7 of the body 5 of the user, in particular in this case the two arms of the user.

In greater detail, the first element 2 and the second element 6 respectively comprise a first arm 34 and a second arm 35 that are able to rotate, independently from one another, about predetermined centres of rotation.

At the ends of the first arm 34 and the second arm 35 there are, respectively, a first grip 32 and a second grip 33.

Like in the previous embodiment of the invention, the first element 2 and the second element 6 are thus mobile and comprise respective first resistant means 30 and second resistant means 31.

The first resistant means 30 and second resistant means 31 respectively comprise a first weight stack 30a and a second weight stack 31a, slidably associated with the frame 13.

The first resistant means 30 and the second resistant means 31 also respectively comprise a first rope-sheave system 30b and a second rope-sheave system 31b (or chain-pulley system), through which the first weight stack 30a and the second weight stack 31a can be raised by the user 5.

Also in this embodiment of the invention, the first vibration generating means 9 and the second vibration generating means 10 are respectively connected to the first weight stack 30a and to the second weight stack 31a.

The operation of the equipment 1 is absolutely analogous to that described for the previous embodiments, in terms of management of the production of vibrations by the first generation means 9 and the second generation means 10.

According to an alternative operating mode, the user can exercise by subjecting only one of the portions 3,7 of the body to vibrations, for example in the case of rehabilitation therapy.

Another embodiment of the gymnastic equipment 1 according to the present invention is illustrated in FIGS. 10,11.

In this embodiment, the gymnastic equipment 1 is of the so-called “chest press” type, through which the user can carry out exercises for the pectoral muscle groups according to free trajectories.

The equipment 1 illustrated comprises a support frame 13, and a seat 27.

The first and second element 2,6 of the equipment 1 respectively comprise first and second resistant means 30,31 comprising a single weight stack 36, and a single rope-sheave system 37, to the ends of which 37a,37b a first and a second grip 32,33 are connected.

The simultaneous traction exerted on the first and on the second grip 32,33 thus determines the lifting of the single weight stack 36.

According to an aspect of the present embodiment of the invention, the first vibration generating means 9 and the second vibration generating means 10 are respectively provided along the single rope-sheave system 37.

In greater detail, the first vibration generating means and the second vibration generating means 10 are associated, in this case, respectively with the first grip 32 and with the second grip 33.

The first vibration generating means 9 and the second vibration generating means 10 could however be associated with the rope-sheave system 37 in other positions thereof.

In this embodiment of the invention, the user can carry out exercises according to free trajectories, but with the vibrations generated at points very close to those for gripping, to avoid dispersion effects along the rope-sheave system 37.

The operation of the equipment 1 is analogous to that described for the previous embodiments.

Another embodiment of the gymnastic equipment 1 according to the invention is illustrated in FIGS. 12,13.

In this embodiment, the equipment 1 is of the so-called “rear deltoid” type, through which the user can carry out exercises for the deltoid muscle groups.

Also in this case, it is a equipment in which the movements of the upper limbs take place according to guided trajectories.

The equipment 1 comprises a support frame 13 and a seat 27.

The first and the second element 2,6 respectively comprise a first rod 38 and a second rod 39 able to rotate about predetermined articulation axes.

The first rod 38 and the second rod 39 respectively comprise a first grip 32 and a second grip 33 for the user.

The first and second resistant means 30,31 comprise a single weight stack 36 and a single rope-sheave system 37, having the ends respectively associated with the first rod 38 and with the second rod 39.

According to an aspect of the present embodiment of the invention, the first vibration generating means 9 and the second vibration generating means 10 are directly coupled, respectively, with the first rod 38 and with the second rod 39, thus advantageously in positions very close to those for gripping, so as to minimise the dispersions and improve the transmission of vibrations to the portions of the body involved.

The first vibration generating means 9 and the second vibration generating means 10 are housed inside respective box-shaped housings fixedly connected, respectively, to the first rod 38 and to the second rod 39.

The operation of the equipment 1 according to the present embodiment is analogous to that described for the previous embodiments.

It has thus been seen how the invention achieves the proposed purposes.

The present invention has been described according to preferred embodiments, but equivalent variants can be devised without departing from the scope of protection offered by the following claims.

1. Gymnastic equipment, comprising a first element, which is fixed or movable, adapted to interact exclusively with a first portion of the user's body,
a second element, which is fixed or movable, adapted to interact exclusively with a second portion of the user's body,
said first portion and said second portion being arranged on opposite sides with respect to the sagittal plane of the user's body, first vibration generating means associated to said first element,
second vibration generating means associated to said second element, and
a control unit to which said first vibration generating means and said second vibration generating means are operatively connected,
wherein said control unit comprises independent actuation means of said first vibration generating means and of said second vibration generating means adapted for actuating said first means and said second means in respective first and second time periods alternating with each other in sequence and not overlapping.

2. The equipment according to claim 1, wherein between said first time period and said second time period respective intermediate time intervals are foreseen, having value zero or greater than zero.

3. The equipment according to claim 2, wherein said independent actuation means comprise a first local unit and a second local unit adapted to control the actuation of said first vibration generating means and of said second vibration generating means, respectively, which units are operatively slaved to a supervision unit.

4. The equipment according to claim 3, wherein said first local unit and said second local unit comprise respective first adjusting means of the duration of the first time period wherein said first vibration generating means are operative, and second adjusting means of the second time period wherein said second vibration generating means are operative.

5. The equipment according to claim 3, wherein said first local unit and said second local unit comprise respective first selecting means of the frequency and/or the amplitude of the vibration produced by said first generating means, and second selecting means of the frequency and/or the amplitude of the vibration produced by said second generating means.

6. The equipment according to claim 3, wherein said supervision unit comprises means for varying said intermediate time intervals.

7. The equipment according to claim 1, wherein said first element and said second element comprise respective independent plates, not mechanically connected to each other, on which the user puts the one and the other foot.

8. The equipment according to claim 7, wherein said first element and said second element are fixed and comprise respective plates on which the user puts both feet while substantially standing.

9. The equipment according to claim 1, comprising at least a support frame, wherein said first element and said second element are movable and comprise respective first resistant means and second resistant means.

10. The equipment according to claim 9, wherein said first resistant means and said second resistant means comprise a first weight stack and a second weight stack, respectively, or a single weight stack, which stacks are slidably associated to said frame, and further a first rope-sheave or chain-pulley system and a second rope-sheave or chain-pulley system, or a single rope-sheave or chain-pulley system, by which said first weight stack and said second weight stack, or said single weight stack, can be raised by the user.

11. The equipment according to claim 10, wherein said first vibration generating means and said second vibration generating means are connected to said first weight stack and to said second weight stack, respectively.

12. The equipment according to claim 10, wherein said first vibration generating means and said second vibration generating means are respectively provided along said first rope-sheave, or chain-pulley system, and along said second rope-′sheave, or chain-pulley system.

13. The equipment according to claim 11, wherein said first vibration generating means and said second vibration generating means are associated to respective movable arms movable rods or to other movable components of the equipment.

14. The equipment according to claim 1, wherein said intermediate time intervals respectively comprised between said first time period and said second time period, and then between said second time period and the next first time period, can be of the same duration, or of different duration.

15. The equipment according to claim 1, wherein said first time period and said second time period have values of less than 3 seconds.

16. The equipment according to claim 1, wherein said first time period and said second time period both have a value roughly equal to 3 seconds, or exactly equal to 3 seconds.

17. The equipment according to claim 2, wherein said intermediate time intervals have values of less than 2 seconds.

18. The equipment according to claim 2, wherein said intermediate time intervals have a value roughly equal to 2 seconds, or exactly equal to 2 seconds.

19. The equipment according to claim 4, wherein said first local unit and said second local unit comprise respective first selecting means of the frequency and/or the amplitude of the vibration produced by said first generating means, and second selecting means of the frequency and/or the amplitude of the vibration produced by said second generating means.

20. The equipment according to claim 4, wherein said supervision unit comprises means for varying said intermediate time intervals.
